(19) United States
(12) Patent Application Publication
(10) Pub. No.: US 2025/0357019 A1
(43) Pub. Date: Nov. 20, 2025

(54) Cable and Cable Assembly

(71) Applicants: Tyco Electronics (Dongguan) Ltd., Dongguan City (CN); Tyco Electronics (Shanghai) Co., Ltd., Shanghai (CN)

(72) Inventors: Zhiwei (Jack) Guo, Dongguan (CN); Chaofeng Wang, Dongguan (CN)

(73) Assignees: Tyco Electronics (Dongguan) Ltd., Dongguan City (CN); Tyco Electronics (Shanghai) Co., Ltd., Shanghai (CN)

(21) Appl. No.: 19/210,244

(22) Filed: May 16, 2025

(30) Foreign Application Priority Data
May 17, 2024 (CN) 202410620642.5
Jun. 26, 2024 (CN) 202410843773.X

(51) Int. Cl. H01B 7/02; H01B 7/20; H01B 11/00; H01B 11/10

(52) U.S. Cl. CPC H01B 7/0216; H01B 7/20; H01B 11/002; H01B 11/1091

(57) ABSTRACT

A cable includes at least two insulated core wires, an insulation structure, a first shielding layer, a second shielding layer, and a second insulation layer. Each insulated core wire includes a conductive wire core and a first insulation layer wrapped over the conductive wire core. The insulation structure is wrapped around an outside of the at least two insulated core wires and fixedly positions the at least two insulated core wires therein. The second insulation layer is circumferentially wrapped around an outside of both the first shielding layer and the second shielding layer. Each of the first shielding layer and the second shielding layer circumferentially surrounds a portion of an outer circumferential surface of the insulation structure and together form a combined shielding layer circumferentially wrapped over the entire outer circumferential surface of the insulation structure.

### CROSS-REFERENCE TO RELATED APPLICATIONS

This application claims the benefit of the filing date under 35 U.S.C. § 119(a)-(d) of Chinese Patent Applications No. 202410620642.5 filed on May 17, 2024, and No. 202410843773.X filed on Jun. 26, 2024.

### FIELD OF THE INVENTION

Embodiments of the present disclosure generally relate to a cable, and more particularly, to a cable capable of increasing a data transmission rate at least by improving the SI performance, and a cable assembly including the cable.

### BACKGROUND OF THE INVENTION

A conventional structure of a data transmission cable mainly includes a conductor, an internal insulation tape wrapped around the conductor, an internal conductive shielding tape wrapped around the internal insulation tape, a grounding wire, an external conductive shielding tape wrapped around the internal conductive shielding tape and the grounding wire, and an external insulation tape including an external conductive shielding tape. However, a high-frequency test bandwidth that the conventional structure can achieve is low, thereby meaning the conventional structure cannot meet the requirements of higher-frequency data transmission. The conventional structure thus has unstable high-frequency performance.

Moreover, in the conventional structure of the cable, two overlapped layers of conductive shielding tapes are used to provide a shielding effect, but the requirements for the overlapped positions thereof are strict, the requirements for the process are extremely high, and the defect rate is high. Furthermore, the conventional cable structure requires the use of two layers of metal tape, and the overlapped position of the two layers of the conductive shielding tapes may fluctuate or deviate due to the influence of the manufacturing processes, affecting the quality of removing metal tape during assembly and easily generating burrs of the metal, thereby affecting the SI performance. In addition, only a spirally wrapping process can be used to wrap the outermost external insulation tape. During wrapping, the interior grounding wire will be pulled away from the middle position, so that the cable structure is unstable and the stability of the SI performance is poor. Moreover, there is a wrapping pitch in the wrapped external insulation tape, so that the bandwidth of the conventional cable structure cannot be increased, and the maximum transmission rate can only reach 224 Gbps.

### SUMMARY OF THE INVENTION

A cable includes at least two insulated core wires, an insulation structure, a first shielding layer, a second shielding layer, and a second insulation layer. Each insulated core wire includes a conductive wire core and a first insulation layer wrapped over the conductive wire core. The insulation structure is wrapped around an outside of the at least two insulated core wires and fixedly positions the at least two insulated core wires therein. The second insulation layer is circumferentially wrapped around an outside of both the first shielding layer and the second shielding layer. Each of the first shielding layer and the second shielding layer circumferentially surrounds a portion of an outer circumferential surface of the insulation structure and together form a combined shielding layer circumferentially wrapped over the entire outer circumferential surface of the insulation structure.

### BRIEF DESCRIPTION OF DRAWINGS

The invention will now be described by way of example with reference to the accompanying figures, of which:

FIG. 1 is a cross-sectional view of a structure of a cable according to an exemplary embodiment;

FIG. 2 is a cross-sectional view of a structure of a cable according to another exemplary embodiment;

FIG. 3 is a cross-sectional view of a structure of a cable according to another exemplary embodiment;

FIG. 4 is a cross-sectional view of a structure of a cable according to another exemplary embodiment;

FIG. 5 is a cross-sectional view of a structure of a cable according to another exemplary embodiment;

FIG. 6 is a cross-sectional view of a structure of a cable according to another exemplary embodiment;

FIG. 7 is a cross-sectional view of a structure of a cable according to another exemplary embodiment;

FIG. 8 is a cross-sectional view of a structure of a cable according to another exemplary embodiment;

FIG. 9 is a cross-sectional view of a structure of a cable according to another exemplary embodiment;

FIG. 10 is a cross-sectional view of a structure of a cable according to another exemplary embodiment; and

FIG. 11 is a cross-sectional view of a structure of a cable assembly according to another exemplary embodiment.

### DETAILED DESCRIPTION

Embodiments of the present disclosure will be described hereinafter in detail taken in conjunction with the accompanying drawings. In the description, the same or similar parts are indicated by the same or similar reference numerals. The description of each of the embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

In addition, the terms used herein are for the purpose of describing exemplary embodiments only and is not intended to limit and or restrict the present disclosure. The singular forms “a,” “an” and “the” are intended to include the plural forms as well, unless the context clearly indicates otherwise. In the present disclosure, the terms “including,” “comprising,” “having,” and the like are used to specify features, numbers, steps, operations, elements, components, or combinations thereof, but do not preclude the presence or addition of one or more of the features, numbers, steps, operations, elements, components, or combinations thereof.

Although the terms “first,” “second,” etc., may be used herein to describe various elements, these elements are not limited by these terms. These terms are only used to distinguish one element from another element. For example, without departing from the scope of the present disclosure, a first element may be termed as a second element, and a second element may be termed as a first element. The term “and/or” includes a plurality of combinations of relevant items or any one item among a plurality of relevant items.

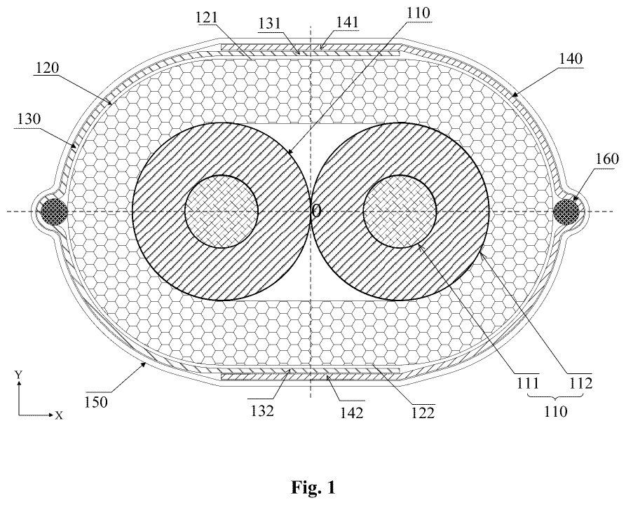

Various exemplary embodiments of a cable will now be described with reference to the various embodiments shown in FIGS. 1-11. The cable may be a high-speed cable, e.g., having a transmission rate of up to 224 Gbps, even 448 Gbps. Like reference numerals shown in FIGS. 1-11 refer to like elements. However, some of the exemplary embodiments of the cable as shown in FIGS. 1-11 only have some of the elements as described below.

In the exemplary embodiments shown in FIGS. 1-11, each cable embodiment includes at least two insulated core wires 110 for transmitting power or data signals. Each insulated core wire 110 extends longitudinally and includes a conductive wire core 111 and a first insulation layer 112 circumferentially wrapped over and contacting the entire conductive wire core 111 to electrically insulate the conductive wire core 111. As used herein, the conductive wire core 111 refers to the conductive core itself made of a conductive material and does not include an insulating material, for example being only composed of a conductor. As an example, each conductive wire core 111 may be made of a high-conductivity material such as a copper conductor, a silver-plated conductor, or the like. Without limiting the current disclosure, each conductive wire core 111 may be a single wire core formed by a single conductor, or a twisted wire core formed by two or more conductors.

As shown in FIGS. 1-11, each cable embodiment further includes an insulation structure 120, which extends longitudinally along the insulated core wire 110 and is wrapped around an outside of each insulated core wire 110 to fixedly position each insulated core wire 110. Each insulation structure 120 may provide electrical insulation and protection functions for the insulated core wire 110. Each insulated core wire 110 positioned within each insulation structure 120 may be maintained in such a way that outer circumferential surfaces of individual insulated core wires 110 are abutted against each other such that the insulated core wires 110 are fixedly positioned relative to each other.

In the illustrated exemplary embodiments, the insulation structure 120 may have a ring-shaped structure or a ring-shaped cross-section, and partially contacts (e.g., is bonded to) an outer circumferential surface of the first insulation layer 112 of each insulated core wire 110. As an example, a hollow portion including a generally elliptical cross-section may be defined within the insulation structure 120, and each insulated core wire 110 is positioned within the hollow portion defined by the insulation structure 120. For example, two insulated core wires 110 are symmetrically maintained within the hollow portion, and the two insulated core wires 110 may be spaced apart along a long axis direction of the elliptical shape. For example, centers of the two insulated core wires 110 may coincide with two focal points of the elliptical shape, respectively.

In this case, as shown in FIGS. 1-4, there may be a certain space or gap between a portion of the insulation structure 120 and the insulated core wires 110, so that the cable may be soft or have a certain flexibility; thus, the cable may be easily bent during assembling or using the cable, facilitating operation. However, this disclosure is not limited to this, and the cross-sectional shape of the insulation structure 120 and the arrangement of the insulated core wires 110, etc., may be changed according to actual needs. For example, in various other embodiments, said space or a space between the individual insulated core wires 110 may be at least partially filled with the material of the insulation structure 120 or other fillers, or the insulation structure 120 is formed so that there is substantially no gap between the individual insulated core wires 110 and the insulation structure 120.

As shown in FIGS. 1-11, the cable further includes a first shielding layer 130, a second shielding layer 140, and a second insulation layer 150 circumferentially wrapped around outsides of both the first shielding layer 130 and the second shielding layer 140. Unlike a conventional technique, the first shielding layer 130 and the second shielding layer 140 are circumferentially wrapped over a portion of the outer circumferential surface of the insulation structure 120, respectively. Thus, the first shielding layer 130 and the second shielding layer 140 together form a combined shielding layer wrapped over the entire outer circumferential surface of the insulation structure 120. The combined shielding layer may be grounded directly or by the grounding wire 160 or drain wire, described in more detail below, so as to provide shielding function for the cable. The shielding function, for example, suppresses electromagnetic interference, protects signals from external interference, reduces signal leakage, provides grounding protection, and also improves the durability of the cable. The improved durability prevents physical damage to the cable caused by, for example, squeezing, stretching, or bending, thereby extending the service life of the cable.

In the conventional cable, when the shielding layer surrounds the interior insulation layer in the form of a complete loop in a circumferential direction, usually it cannot be fitted snugly on the interior insulation layer very well. In addition, when an insulation tape is wound or spirally wrapped on a turn-by-turn basis around an outside of the interior insulation layer along the length of the cable, the winding or spirally wrapping is time-consuming and inefficient, and there is a winding or spirally wrapping pitch, resulting in echo loss, and thus, the high-frequency test bandwidth of the conventional cable with this structure cannot meet the requirements of higher speed data transmission, and the stability of the SI performance of the cable is poor.

However, in the embodiments of the present disclosure as shown in FIGS. 1-11, unlike the winding or spirally wrapping structure, each of the first shielding layer 130 and the second shielding layer 140 is a semi-longitudinally wrapping layer that extends continuously along the entire length of the cable. The shielding layer in the form of the semi-longitudinally wrapping may be formed as a substantially semi-tubular structure that is circumferentially wrapped (e.g., fitted or disposed snugly on or contacts) over the insulation structure 120 and extends along the length or longitudinal direction of the cable, so that it may be better fitted or disposed snugly (e.g., bonded by hot-melting or by an adhesive) on the insulation structure 120, thereby: (1) improving the stability of the SI performance of the cable; (2) eliminating the pitch of the conventional spirally wrapping structures; and (3) further eliminating the overall echo loss caused by the spirally wrapping structure, increasing the frequency bandwidth of the cable. For example, the frequency bandwidth of the cable may be more easily increased from 60 GHz to 112 GHz or even higher, thereby being capable of meeting the requirements of the high-speed data transmission, for example 448 Gbps. The first shielding layer 130 and the second shielding layer 140 may include a metal shielding layer or tape. For example, the first shielding layer 130 and the second shielding layer 140 may include an insulation tape layer or tape and a conductive layer (such as a metal layer) adhered to the insulation tape layer or tape.

A mold may be used to perform the operation of fitting the shielding layer with a semi-longitudinally wrapping configuration. For example, a wrapping material for the shielding layer is supplied into the mold, and while the semi-finished product (for example, the insulated wire core already wrapped with the insulation structure 120) of the cable travels longitudinally, the wrapping material of the shielding layer is fitted or disposed snugly (e.g., bonded by hot-melting or by an adhesive) on the inner structure (e.g., the insulation structure 120) using the mold. Removing the spirally wrapping structure may also eliminate the limitation of the production efficiency due to the wrapping speed of a spirally wrapping machine, and also reduce the cost.

In the exemplary embodiments, the first shielding layer 130 and the second shielding layer 140 may be arranged to be opposite in a radial direction (for example opposite in the X direction in the figures; the radial direction parallel to the X direction may herein be referred to as the first radial direction). Each shielding layer extends longitudinally and circumferentially surrounds at least half of the outer circumferential surface of the insulation structure 120 (for example in the form of a substantially semi-ring facing the other), so that the combination of the first shielding layer 130 and the second shielding layer 140 circumferentially surrounds the entire circumference of the insulation structure 120. As an example, cross-sectional shapes of the first shielding layer 130 and the second shielding layer 140 substantially correspond or match cross-sectional shapes of the outer circumferential surface of the interior insulation structure 120, and may have approximately C-shaped or U-shaped cross-sections, respectively.

In the embodiments shown in FIGS. 1-11, the first shielding layer 130 and the second shielding layer 140 at least partially overlap in a circumferential direction of the insulation structure 120 to form a generally annular combined shielding layer. For example, as shown in FIGS. 1-11, the first shielding layer 130 and the second shielding layer 140 may overlap at different positions or sections on the outer circumferential surface of the insulation structure 120, for example, at two positions or sections on the outer circumferential surface of the insulation structure 120 that are opposite in a radial direction (for example, opposite in Y direction in the figures; the radial direction parallel to the Y direction may herein be referred to as the second radial direction).

In the illustrated embodiments, the first shielding layer 130 and the second shielding layer 140 overlap with each other at or near two middle positions or sections of the outer circumferential surface of the insulation structure 120 in the X direction or the first radial direction (for example, at or near the upper and lower middle positions or sections in the figures, whose centers may be substantially aligned with a cross-sectional center O of the cable in the Y direction or the second radial direction). However, the present disclosure is not limited to this. In various other embodiments, the position where the first shielding layer 130 and the second shielding layer 140 overlap with each other may vary according to actual applications. For example, the first shielding layer 130 and the second shielding layer 140 may be located at or near two middle positions or sections of the outer circumferential surface of the insulation structure 120 in the Y direction or the second radial direction (for example, at or near the left and right middle positions or sections in the figures, whose centers may be substantially aligned with the cross-sectional center O of the cable in the X direction or the first radial direction), or may deviate from the above-mentioned two middle positions or sections.

In the case that the position where the first shielding layer 130 and the second shielding layer 140 overlap each other is located at or near the above-mentioned middle positions or sections of the outer circumferential surface of the insulation structure 120, the electric/magnetic fields generated by the interior two or more insulated core wires 110 during operation is relatively small at the above-mentioned middle positions or sections (for example, in some cases, they are counteracted with each other). Thus, the influence of the first shielding layer 130 and the second shielding layer 140 on the electric/magnetic field and the interference of the first shielding layer 130 and the second shielding layer 140 on signal transmission may be reduced.

In some exemplary embodiments, as shown in FIGS. 1 and 4-10, the outer circumferential surface of the insulation structure 120 may have a first flat portion 121 and a second flat portion 122 at or near two positions or sections (e.g., two middle positions or sections in the X direction or the first radial direction) opposite to each other in the radial direction (e.g., in the Y direction). As shown in FIGS. 1-10, the first shielding layer 130 may have a first end section 131 and a second end section 132 that are opposite in a circumferential direction, and the second shielding layer 140 may have a third end section 141 and a fourth end section 142 that are opposite in a circumferential direction. As shown in FIGS. 1 and 4-10, the first end section 131 and the third end section 141 are fitted or disposed snugly on the first flat portion 121 in such a manner that they at least partially overlap with each other, and the second end section 132 and the fourth end section 142 are fitted or disposed snugly on the second flat portion 122 in such a manner that they at least partially overlap with each other. At least one of the first end section 131, the second end section 132, the third end section 141, and the fourth end section 142 may be a straight section, so as to facilitate the fitting (such as squeezing and bonding) on the flat portion of the insulation structure 120. The first end section 131 and the third end section 141 may be joined with each other, and the second end section 132 and the fourth end section 142 may be joined with each other. This joining may be a bonding achieved, for example, by hot melting or by an adhesive or an adhesion coating provided or otherwise added to the inner side surface of the respective shielding layer.

In some examples, the first flat portion 121 and the second flat portion 122 of the insulation structure 120 may extend approximately parallel to a tangent line that is tangent to all the outer circumferential surfaces of the two or more interior insulated core wires 110. The tangent line may be approximately parallel to the X direction or the first radial direction or approximately parallel to a virtual line connecting the centers of the interior insulated core wires 110. The provision of the flat portion of the insulation structure 120 not only facilitates the fitting operation of the overlapped portions of the first shielding layer 130 and the second shielding layer 140 on the flat portion, but also makes an outer contour or shape of the cable also being substantially flat or straight at the flat portion, which facilitates the arrangement and stable positioning of the cable in use.

As shown in FIGS. 1-11, the portions where the first shielding layer 130 and the second shielding layer 140 overlap with each other may be symmetrical with respect to a center line of the cable parallel to the X or Y direction, so that the effects of the first shielding layer 130 and the second shielding layer 140 on the electric/magnetic field generated by the two interior insulated core wires 110 during operation and signal transmission are the same or balanced with each other. For example, as shown in FIGS. 1-4, the first end section 131 and the third end section 141 which are overlapped are symmetrical with respect to the center line of the cable parallel to the Y direction. The third end section 141 and the fourth end section 142 which are overlapped are symmetrical with respect to the center line of the cable parallel to the Y direction.

In the exemplary embodiments of the present disclosure, a mold may be used to fit the first shielding layer 130 and the second shielding layer 140, which are each in the form of semi-longitudinally wrapping layer, on the insulation structure 120, so that the positions of the first end section 131 and the third end section 141, which overlap with each other, relative to the central axis of the cable in the circumferential direction, and the positions of the second end section 132 and the fourth end section 142, which overlap with each other, relative to the central axis of the cable in the circumferential direction, are fixed along the entire length of the cable. That is, the positions where the first shielding layer 130 and the second shielding layer 140 overlap with each other are longitudinally aligned along the entire length of the cable, which can effectively reduce burrs caused by unfixing of the overlapping positions during removing the first shielding layer 130 and/or the second shielding layer 140 by a laser, and improve the stability of the SI performance.

In some exemplary embodiments of the present disclosure, the second insulation layer 150 as the external insulation layer may include a full-longitudinally wrapping layer that extends continuously in a tubular shape along the entire length of the cable and is circumferentially wrapped around both the first shielding layer 130 and the second shielding layer 140. Therefore, instead of the spirally wrapping arrangement of the outer insulation layer in the conventional cable, the exemplary embodiments of the present disclosure propose an external insulation layer with the full-longitudinally wrapping arrangement. The longitudinally wrapping arrangement eliminates the conventional spirally wrapping structure, so that the second insulation layer 150 could be better fitted or disposed snugly on the internal structure, and the overall echo loss caused by the spirally wrapping structure is eliminated, so that the frequency bandwidth of the cable may be more easily increased to 112 GHz or even higher, thereby meeting the requirements of data transmission, such as at 224 Gbps, 448 Gbps or even higher speed. Similarly, a mold may be used to perform the fitting operation of the second insulation layer 150 with a full-longitudinally wrapping configuration.

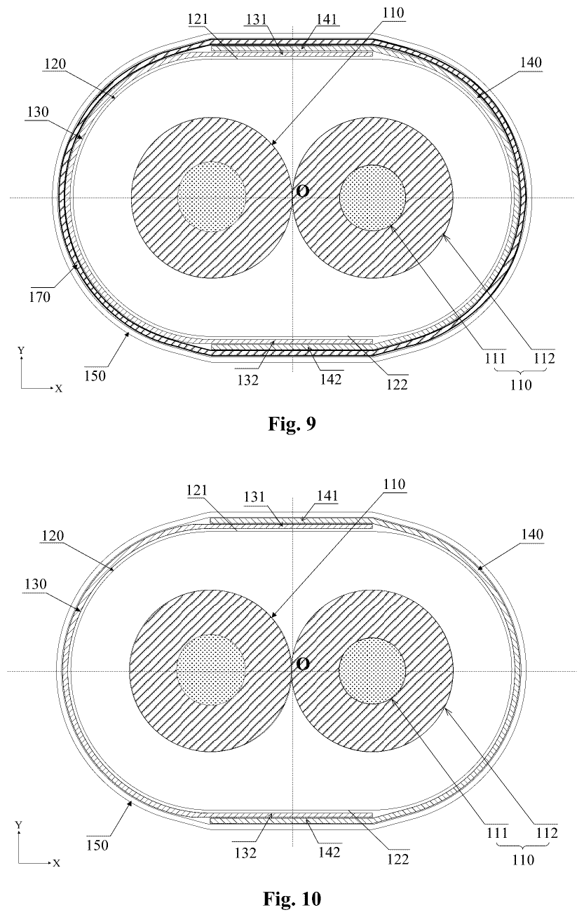

As an example, the second insulation layer 150 may include a single full-longitudinally wrapping layer or an insulation tape, or may include two or more full-longitudinally wrapping layers or insulation tapes stacked or arranged to be concentric with each other. For example, as shown in FIGS. 6 and 8, the second insulation layer 150 may include two sub-insulation layers 151, 152, which may be ring-shaped and be concentrically wrapped around an outside of both the first shielding layer 130 and the second shielding layer 140. In the case of adopting the single full-longitudinally wrapping layer or insulation tape, a side of the second insulation layer 150 provided with an adhesive may face inwardly to be bonded to the interior cable structure and fixedly position the interior cable structure, such as, the shielding layer and/or the grounding wire 160. In the case of adopting the two or more full-longitudinally wrapping layers or insulation tapes, sides of the full-longitudinally wrapping layers or insulation tapes of adjacent layers provided with an adhesive may face each other and be bonded to each other. In other embodiments, the second insulation layer 150 may be in the form of an outer sheath, such as a protective sleeve.

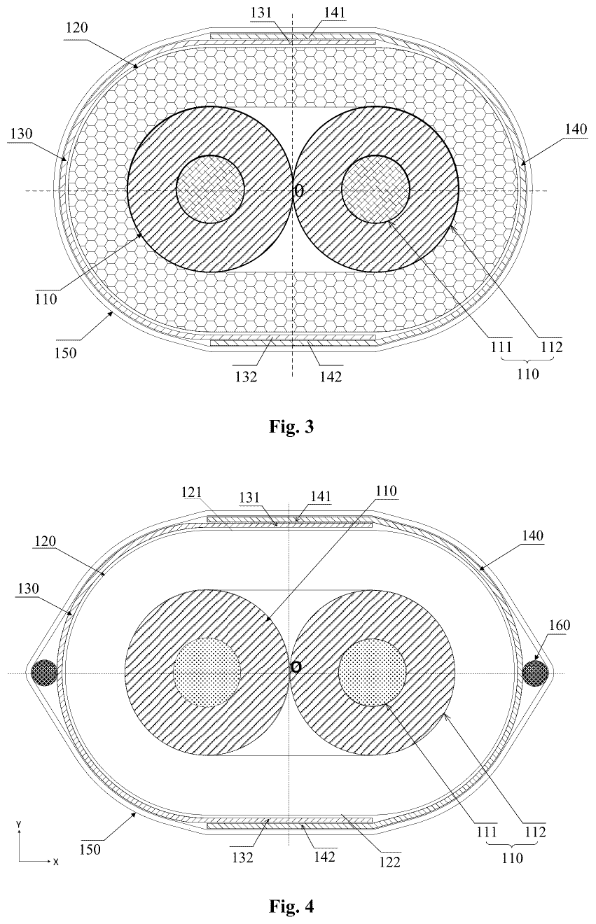

In embodiments of the present disclosure, the first insulation layer 112, the insulation structure 120, and the second insulation layer 150 may be made of an insulation material such as polyester, polyethylene, polypropylene, polyvinyl chloride, polytetrafluoroethylene, polyperfluoro ethylene-propylene, polyvinylidene fluoride, tetrafluoroethylene, ethylene copolymer, polyolefin, polyethylene terephthalate (“PET”) or the like. In addition, the materials of the first insulation layer 112 and the insulation structure 120 may be chosen so that the electrical and/or mechanical properties of the insulation structure 120 are different from those of the first insulation layer 112. For example, in some embodiments, the first insulation layer 112 or the insulation structure 120 may include a foamed or porous insulation material (e.g., as schematically shown in FIGS. 1-3) to reduce or easily adjust a dielectric constant of the cable. For example, the insulation structure 120 may be formed by wrapping (such as spirally wrapping) a foamed or porous insulation tape around the outer circumferential surface of the first insulation layer 112. But the present disclosure is not limited to this, and for example, as shown in FIG. 4, the insulation structure 120 may be only a spirally wrapped insulation tape.

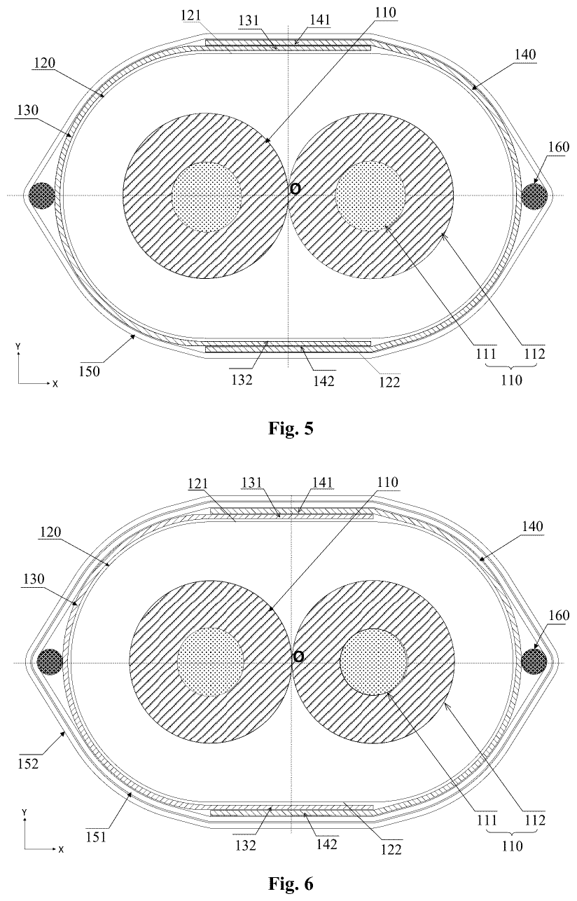

In other embodiments, the insulation structure 120 may be in the form of an insulation sheath, which may be referred to as an intermediate sheath or middle insulation structure, and is sleeved on the outer circumferential surface of the first insulation layer 112 of each insulated core wire 110 and is used to fix the relative position of each insulated core wire 110. In some examples, the insulation structure 120 may include a single extruded structure that is circumferentially wrapped around and contacts with the outer circumferential surface of the first insulation layer 112 of each insulated core wire 110, such that, for example, there is substantially no gap between the insulation structure 120 and the outer circumferential face of the first insulation layer 112, as shown in FIGS. 5-10. As an example, the insulation structure 120 may be formed by an extrusion molding process. For example, the individual insulated core wires 110 may be closely squeezed together with the insulation material, which is used for forming the insulation structure 120, in a mold, such that, for example, the individual insulated core wires 110 and the insulation material are in close contact with each other, and then they are extruded out from the mold. Consequently, there is substantially no gap between the extruded insulation structure 120 and the outer circumferential surface of the first insulation layer 112, and the insulation structure 120 may firmly maintain the position of each insulated core wire 110 therein. Therefore, the internal insulation structure of the cable is divided into the core wire insulation structure and the middle insulation structure, such that the cable is softer and more resistant to bending when compared to the conventional cable formed by a double extrusion and one-step molding. In addition, the insulation structure 120 may also be formed from a foamed or porous insulating material by an extrusion process so as to improve the electrical properties of the cable.

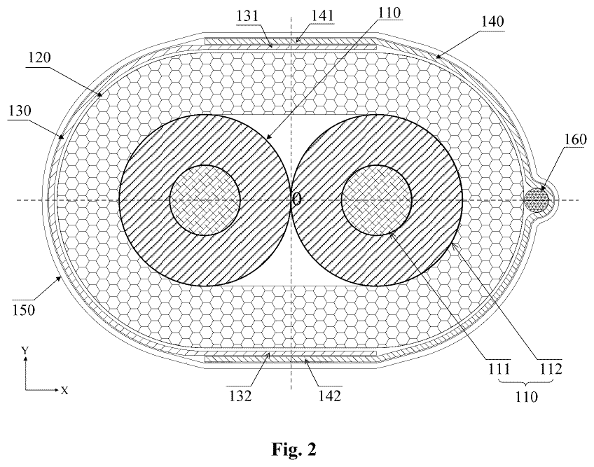

In some embodiments, as shown in FIGS. 1-2 and 4, the cable may further include a separately provided grounding wire 160 or drain wire, such as at least one grounding wire 160 being in electrical contact with at least one shielding layer of the first shielding layer 130 and the second shielding layer 140, to enhance the electromagnetic shielding effect of the cable. The at least one grounding wire 160 may be provided between the first shielding layer 130 and/or the second shielding layer 140 and the insulation structure 120, as shown in FIGS. 1-2. In other embodiments, as shown, for example, in FIGS. 4-5, the at least one grounding wire 160 may be provided on outsides of the first shielding layer 130 and/or the second shielding layer 140, for example, being located between the second insulation layer 150 and the first shielding layer 130 and/or the second shielding layer 140. In the embodiments shown in FIGS. 1 and 4-7, two grounding wires 160 are provided, for example, on the radially opposite outer sides of the insulation structure 120. In FIG. 2, only a single grounding wire 160 is provided on one side of the cable. In FIGS. 3 and 8-10, there is no separate grounding wire 160 or drain wire provided in the cable, and the first shielding layer 130 and/or the second shielding layer 140 may be adapted to be connected with the external grounding and thus function as a grounding wire.

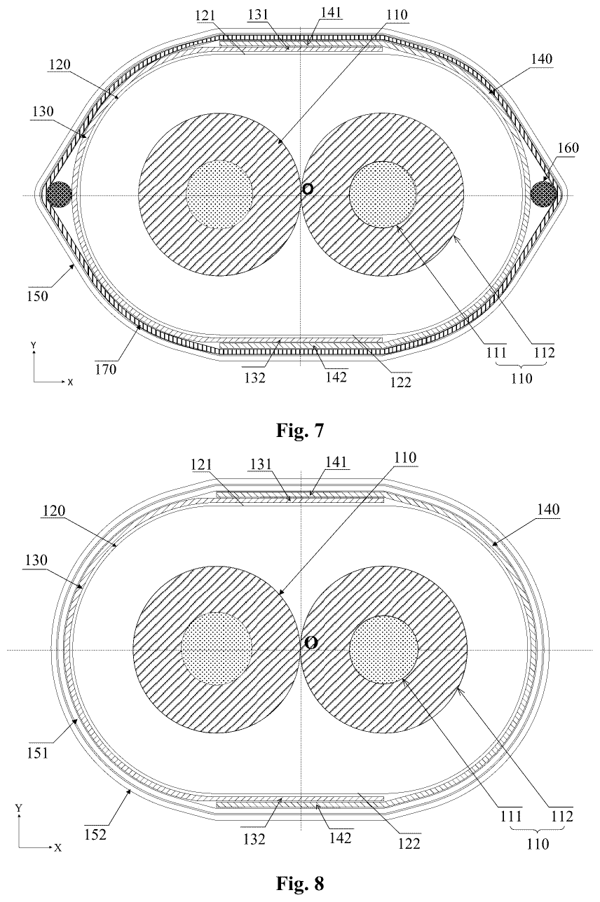

Illustratively, as shown in FIGS. 1-2, the grounding wire 160 may be positioned (e.g., bonded by an adhesive) on an inside of the first shielding layer 130 and/or the second shielding layer 140, and in this case, the metal or conductive layer of the first shielding layer 130 and/or the second shielding layer 140 face inwardly to make electrical contact with the grounding wire 160, which may enhance the overall EMC and EMI capabilities of the cable, further improving the stability of the electrical performance of the cable. For example, each grounding wire 160 may be positioned at a middle position of the first shielding layer 130 and/or the second shielding layer 140 in the circumferential direction; for example, a center of the grounding wire 160 and a center of the conductive wire core 111 may be located within the same radial plane. Alternatively, as shown in FIGS. 4-7, the grounding wire 160 may be provided on outsides of the first shielding layer 130 and/or the second shielding layer 140, for example, between the second insulation layer 150 and the first shielding layer 130 and/or the second shielding layer 140, and in this case, the metal or conductive layer of the first shielding layer 130 and/or the second shielding layer 140 face outwardly to make in electrical contact with the grounding wire 160. As shown in FIGS. 7 and 9, the cable may also include an outer shielding layer 170, which is provided on an inside of the second insulation layer 150 to be circumferentially wrapped over and be in electrical contact with the first shielding layer 130, the second shielding layer 140, and each grounding wire 160, thus further providing enhanced electromagnetic shielding effect for the grounding wire 160 and/or the entire cable.

According to the embodiments of the present disclosure, since the conventional spirally wrapping structure is removed, and the first shielding layer 130 and the second shielding layer 140 adopt the semi-longitudinally wrapping structure, the position of the grounding wire 160 of the cable may be fixed on its center line using the mold. For example, the grounding wire 160 may be adhered to the inner surface of the first shielding layer 130 and/or the second shielding layer 140 by an adhesive layer, such as an adhesion coating, adhesive, or hot melt adhesive provided on the inner surface of the corresponding shielding layer. The first shielding layer 130 and/or the second shielding layer 140 in the form of the semi-longitudinally wrapping layer could be better fitted and wrapped over the grounding wire 160, so that at least a part of the circumference of each grounding wire 160 may be wrapped by the first shielding layer 130 and/or the second shielding layer 140 and therefore stably fixed, thereby avoiding the offset of the grounding wire 160 caused by the wrapping force of the conventional spirally wrapping tape. The grounding wire 160 extends substantially or is fixed in a straight line along the longitudinal or axial direction of the cable, that is, the position offset of the grounding wire 160 within the longitudinal or length range of the cable is reduced or eliminated.

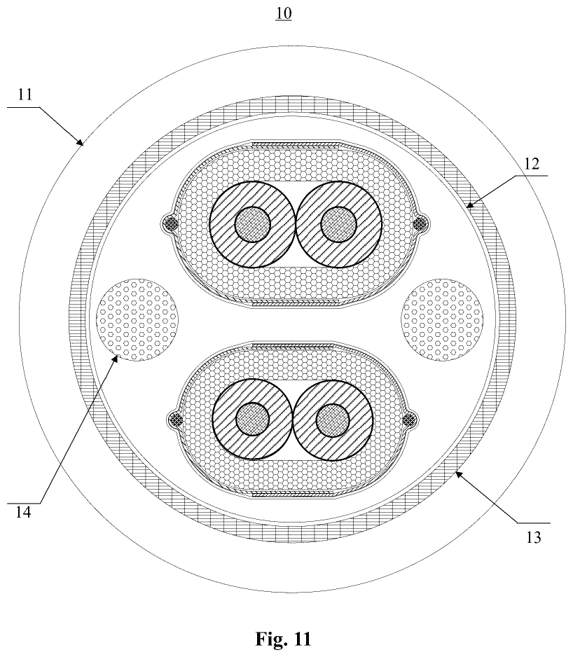

An exemplary embodiment of a cable assembly 10 is now described with reference to FIGS. 1-11. The cable assembly 10, as shown in FIG. 11, includes at least two cables described herein and shown in FIGS. 1-10, which may be disposed within a protective sheath 11. For example, these cables may be parallel, twisted, or wound with respect to each other in the longitudinal direction. The cable assembly 10 may include two or more cables, so that more signal, data, or power transmission functions may be provided, and there is no signal interference between the individual cables.

The protective sheath 11, as shown in FIG. 11, may be in the form of a sleeve, such as a metal tube or a plastic tube, to provide a certain protection for the cable(s). As shown in FIG. 11, the cable assembly 10 may also include a shielding ring 12 as an electromagnetic shielding structure provided within the protective sheath 11. The shielding ring 12 may take the form of a layer/tape of metal or other conductive material that is wrapped or wound around an outside of all the cables to provide further improved electromagnetic shielding effect.

In some examples, as shown in FIG. 11, the cable assembly 10 may further include an additional buffering layer 13, such as a braided layer. The buffering layer 13 is provided within the protective sheath 11. For example, the buffering layer 13 is arranged between the shielding ring 12 and the protective sheath 11 in a circular form, and provides buffering or vibration damping function for the cables. In other examples, a space between the cables and/or a space between the cables and the buffering layer 13 or the shielding structure within the protective sheath 11 may be further at least partially filled with a filler 14, so that the structure of the cable assembly 10 is not easily deformed and remains stable in use.

Although the exemplary embodiments of the present disclosure have been shown and described, it would be appreciated by those skilled in the art that various changes may be made to these embodiments without departing from the principles and spirit of the disclosure, the scope of which is defined by the appended claims and their equivalents. Additionally, it is to be noted that the terms “comprising,” “including,” “having” used therein do not exclude other components or steps. Furthermore, any reference numerals in the claims shall not be construed as limiting the scope of the disclosure.

1. A cable comprising:
at least two insulated core wires, each insulated core wire includes a conductive wire core and a first insulation layer wrapped over the conductive wire core;
an insulation structure wrapped around an outside of the at least two insulated core wires fixedly positions the at least two insulated core wires therein;
a first shielding layer;
a second shielding layer; and
a second insulation layer circumferentially wrapped around an outside of both the first shielding layer and the second shielding layer, each of the first shielding layer and the second shielding layer circumferentially surrounds a portion of an outer circumferential surface of the insulation structure and together form a combined shielding layer circumferentially wrapped over an entire outer circumferential surface of the insulation structure.

2. The cable of claim 1, wherein each of the first shielding layer and the second shielding layer is a semi-longitudinally wrapping layer that extends continuously along an entire length of the cable.

3. The cable of claim 2, wherein the first shielding layer and the second shielding layer are radially opposed, and each of the first shielding layer and the second shielding layer circumferentially surrounds at least half of the outer circumferential surface of the insulation structure.

4. The cable of claim 3, wherein each of the first shielding layer and the second shielding layer has a substantially C-shaped cross-section or a substantially U-shaped cross-section.

5. The cable of claim 3, wherein the first shielding layer and the second shielding layer at least partially overlap with each other in a circumferential direction of the insulation structure and form a ring-shaped combined shielding layer.

6. The cable of claim 5, wherein the first shielding layer and the second shielding layer overlap with each other at two radially opposite positions on the outer circumferential surface of the insulation structure.

7. The cable of claim 6, wherein the outer circumferential surface of the insulation structure has a first flat portion and a second flat portion each located at one of the two radially opposite positions, the first shielding layer has a first end section and a second end section disposed opposite each other in the circumferential direction, the second shielding layer has a third end section and a fourth end section disposed opposite each other in the circumferential direction, the first end section and the third end section at least partially overlap with each other and are disposed snugly on the first flat portion, and the second end section and the fourth end section at least partially overlap with each other and are disposed snugly on the first flat portion.

8. The cable of claim 7, wherein the first end section and the third end section are joined with each other, and the second end section and the fourth end section are joined with each other.

9. The cable of claim 8, wherein positions of the first end section and the third end section are fixed along the entire length of the cable relative to a central axis of the cable in the circumferential direction, and positions of the second end section and the forth end section are fixed along the entire length of the cable relative to the central axis of the cable in the circumferential direction.

10. The cable of claim 1, wherein the second insulation layer includes one or more tubular full-longitudinally wrapping layers or an outer insulation sheath circumferentially wrapped over both the first shielding layer and the second shielding layer and extending continuously along an entire length of the cable; or the second insulation layer comprises one or more layers of insulation tapes.

11. The cable of claim 1, further comprising at least one grounding wire in electrical contact with at least one shielding layer of the first shielding layer and the second shielding layer, the at least one grounding wire is located between the at least one shielding layer and the insulation structure or between the at least one shielding layer and the second insulation layer.

12. The cable of claim 11, wherein the at least one grounding wire only comprises a single grounding wire, the single grounding wire is located between one of the first shielding layer and the second shielding layer and the insulation structure or between one of the first shielding layer and the second shielding layer and the second insulation layer; or the at least one grounding wire comprises two grounding wires symmetrically arranged on opposite sides of the insulation structure, each grounding wire being located between a corresponding one of the first shielding layer and the second shielding layer and the insulation structure or between a corresponding one of the first shielding layer and the second shielding layer and the second insulation layer.

13. The cable of claim 12, further comprising an outer shielding layer provided on an inside of the second insulation layer to be circumferentially wrapped over the first shielding layer, the second shielding layer, and each grounding wire.

14. The cable of claim 12, wherein each grounding wire is bonded to a middle position of a corresponding shielding layer in a circumferential direction by an adhesive coating on an inner side surface of the corresponding shielding layer.

15. The cable of claim 1, wherein at least one of the first shielding layer and the second shielding layer is electrically connected with an external grounding.

16. The cable of claim 1, wherein at least one of the first insulation layer and the insulation structure includes a foamed insulation structure.

17. The cable of claim 1, wherein the insulation structure includes a spirally wrapped insulation tape.

18. The cable of claim 1, wherein the insulation structure includes an intermediate insulation sheath.

19. The cable of claim 18, wherein the intermediate insulation sheath includes a single extruded structure circumferentially wrapped over and contacting an outer circumferential surface of the first insulation layer of each insulated core wire.

20. A cable assembly comprising:
at least two cables, each cable including at least two insulated core wires, an insulation structure, a first shielding layer, a second shielding layer, and a second insulation layer, each insulated core wire includes a conductive wire core and a first insulation layer wrapped over the conductive wire core, the insulation structure is wrapped around an outside of the at least two insulated core wires and fixedly positions the at least two insulated core wires therein, and the second insulation layer is circumferentially wrapped around an outside of both the first shielding layer and the second shielding layer, each of the first shielding layer and the second shielding layer circumferentially surrounds a portion of an outer circumferential surface of the insulation structure and together form a combined shielding layer circumferentially wrapped over an entire outer circumferential surface of the insulation structure;
a shielding ring circumferentially surrounding the at least two cables; and
a protective sheath sleeved on an outside of the shielding ring.
